(19) United States
(12) Patent Application Publication
(10) Pub. No.: US 2026/0346757 A1
(43) Pub. Date: Nov. 5, 2026

(54) ELECTRIC POWER SUPPLY SYSTEM FOR A VEHICLE

(71) Applicants: COMMISSARIAT A L'ENERGIE ATOMIQUE ET AUX ENERGIES ALTERNATIVES, Paris (FR); SCHAEFFLER TECHNOLOGIES AG & CO, KG, Herzogenaurach (DE)

(72) Inventors: Sylvain BACQUET, Grenoble cedex 09 (FR); Ghislain DESPESSE, Grenoble cedex 09 (FR); Damien VERDIER, Toulouse (FR); Jérôme LACHAIZE, Toulouse (FR); Nicolas LETO, Toulouse (FR)

(73) Assignees: COMMISSARIAT A L'ENERGIE ATOMIQUE ET AUX ENERGIES, Paris (FR); SCHAEFFLER TECHNOLOGIES AG & CO, KG, Herzogenaurach (DE)

(21) Appl. No.: 19/125,365

(22) PCT Filed: Nov. 6, 2023
(86) PCT No.: PCT/EP2023/080750

§ 371 Date: Apr. 29, 2025

(30) Foreign Application Priority Data
Nov. 9, 2022 (FR) FR2211693

(51) Int. Cl. B60L 58/22; B60L 1/00

(52) U.S. Cl. CPC B60L 58/22; B60L 1/00; B60L 2210/40

(57) ABSTRACT

An electric power supply system for an electric or hybrid vehicle, the vehicle having an electric power supply bus, including a) at least two power supply cells each having i) a bidirectional transformer, ii) a first battery, iii) a second battery, and iv) a switching cell able to connect the first battery and/or the second battery to the transformer; b) a first switch able to connect the first battery to the power supply bus; c) a second switch able to connect the second battery to the power supply bus; and d) a connection module able to connect a single-phase or three-phase voltage to the power supply cells.

### TECHNICAL FIELD

The invention relates to the field of hybrid or electric vehicles, and more precisely an electrical power supply system for a hybrid or electric vehicle.

### PRIOR ART

As is known, an electric or hybrid vehicle comprises an electric machine for the vehicle propulsion, together with a storage battery designed to be connected to the electric machine. An inverter is connected between the battery and the electric machine and allows the DC voltage supplied by the battery to be converted into an AC voltage, notably a three-phase AC voltage, in order to supply each phase of the electric machine.

The vehicle also comprises an internal auxiliary electrical supply system allowing power to be supplied to the electrical equipment of the vehicle (for example the windshield wipers, the headlights, the indicator lamps of the dashboard, etc.).

The voltage supplied by the auxiliary electrical system is for example 12 or 14 V.

The vehicle also comprises an auxiliary battery designed to supply power to the system and a DC-DC voltage converter connected between the auxiliary battery and the battery in order to recharge the auxiliary battery.

This has the drawback of having to install and set up numerous converters in the vehicle.

Moreover, each battery is in reality composed of an assembly of battery cells connected together in a static manner. The level of charge of each battery depends on the state of charge of each cell. However, the cells may not all have identical electrical and energy characteristics. The sizing of each battery must therefore take into consideration the aging phenomena and performance characteristics of each cell, which is constraining.

Furthermore, the sizing of the components of the converter and of the inverter is determined so that the voltage supplied by the converter and by the inverter are each defined over a wide range of voltages. Thus, since the sizing of each of these elements is not determined for an optimum operating voltage, this may cause losses after each conversion implemented by the converter or the inverter.

There accordingly exists the need for a solution allowing the drawbacks previously described to be, at least in part, overcome.

### DESCRIPTION OF THE INVENTION

For this purpose, the invention relates to an electrical power supply system for an electric or hybrid vehicle, the vehicle comprising an electrical supply bus designed to supply power to electrical equipment installed in the vehicle, said system comprising:
a) at least two power supply cells each comprising:
   i) a bidirectional transformer, designed to supply an AC voltage starting from a DC voltage and vice versa,
   ii) a first battery designed to operate according to a discharge mode, in which the first battery is designed to supply a first DC voltage, and designed to operate according to a charging mode in which the battery is designed to be recharged from a DC voltage,
   iii) a second battery designed to operate according to a discharge mode, in which the first battery is designed to supply a first DC voltage, and designed to operate according to a charging mode in which the battery is designed to be recharged from a DC voltage,
   iv) a switching cell comprising switches designed to connect the first battery and/or the second battery to the transformer,
b) a first switching unit designed to connect the first battery of each power supply cell to the electrical supply bus,
c) a second switching unit designed to connect the second battery to the electrical supply bus,
d) a connection module designed to electrically connect each power supply cell to an electrical supply system, designed to supply an AC voltage, or to electrical equipment external to the vehicle, designed to be supplied from an AC voltage:
   i) if the AC voltage supplied by the power supply system, or if the voltage needed for supplying the electrical equipment, is single-phase, the connection module is designed to connect the single-phase voltage to at least one power supply cell,
   ii) if the AC voltage supplied by the power supply system, or if the voltage needed for supplying the electrical equipment, is three-phase, the connection module is designed to connect each phase of said voltage to a power supply cell specific to it,
e) a control unit configured for controlling the connection module, the first switching unit and the second switching unit,
   the electrical system is designed to operate according to a plurality of operating modes:
   i) a first mode of operation in which the connection module connects each phase of the three-phase voltage supplied by the power supply system to a power supply cell specific to it and, for each power supply cell:
      1) the first battery or the second battery is connected to the power supply bus,
      2) the battery not connected to the power supply bus is connected to the connection module and operates according to the charging or discharge mode,
   ii) a second mode of operation in which the connection module connects the single-phase voltage supplied by the power supply system to at least one power supply cell and, for each power supply cell connected to the single-phase voltage:
      1) the first battery or the second battery is connected to the power supply bus,
      2) the battery not connected to the power supply bus is connected to the connection module and operates according to the charging or discharge mode.

Preferably, if the AC voltage supplied by the power supply system, or if the voltage needed to supply the electrical equipment, is single-phase, the connection module is designed to connect the single-phase voltage to each of the power supply cells. Thus, when the electrical system operates according to the second mode of operation, the connection module connects the single-phase voltage to all the power supply cells.

Thus, the power supply system allows the power supply bus of the vehicle to be supplied while at the same time supplying equipment external to the vehicle or else allows the power supply bus of the vehicle to be supplied by virtue of a first battery while at the same time allowing the second battery to be recharged from a voltage supplied by an electrical power supply system external to the vehicle. Furthermore, the power supply system may also allow the power supply bus to be supplied, alternately, from a first battery or from a second battery, so as to balance the state of charge between each first and second battery. Moreover, the power supply system is operational whether the AC voltage supplied by the electrical network is single-phase or three-phase or whether the AC voltage to be supplied in order to power external electrical equipment is single-phase or three-phase.

The transformer advantageously comprises a galvanic isolation.

The transformers are bidirectional with regard to current.

Advantageously, all of the first batteries of each power supply cell are connected in series, and all of the second batteries of each power supply cell are connected in series.

Preferably, the power supply system is configured to operate according to:
i) a third mode of operation in which:
   1) the connection module connects the single-phase voltage to at least one power supply cell,
   2) each switch of each power supply cell connected to the single-phase voltage is closed,
   3) the first switching unit and the second switching unit are open, such that each battery operates according to the charging mode or according to the discharge mode,
ii) a fourth mode of operation in which:
   1) the connection module is designed to connect each phase of said voltage to a power supply cell specific to it,
   2) each switch of each power supply cell is closed,
   3) the first switching unit and the second switching unit are open, such that each battery operates according to the charging mode or according to the discharge mode.

Thus, the power supply system also allows all of the first and second batteries to be used in order to supply equipment external to the vehicle or to allow the first and second batteries to be recharged from a voltage supplied by an electrical power supply system external to the vehicle. Moreover, the power supply system makes this possible whether the AC voltage supplied by the electrical network is single-phase or three-phase or whether the AC voltage to be supplied in order to power an external electrical equipment is single-phase or three-phase.

Preferably again, the power supply system is configured for operating according to a fifth mode of operation in which the first switching unit and the second switching unit are closed, each switch of each power supply cell being open, such that the first battery and the second battery supply electrical energy to the power supply bus. Thus, the power supply system also allows all of the first and second batteries to be used in order to supply electrical energy to the power supply bus.

Preferably again, the connection module comprises:
a) a first connection terminal electrically connected to the first power supply cell,
b) a second connection terminal,
c) a third connection terminal,
d) a first switch, designed to connect the second power supply cell to the first connection terminal or to the second connection terminal,
e) a second switch designed to connect the third power supply cell to the first connection terminal or to the third connection terminal.

Advantageously again:
a) the first connection terminal is electrically connected to the transformer of the first power supply cell,
b) the first switch is designed to connect the transformer of the second power supply cell to the first connection terminal or to the second connection terminal,
c) the second switch is designed to connect the transformer of the third power supply cell to the first connection terminal or to the third connection terminal.

Preferably again:
a) when the system operates according to the first mode of operation, the first switch of the connection module connects the second connection terminal to the second power supply cell and the second switch of the connection module connects the third connection terminal to the third power supply cell,
b) when the system operates according to the second mode of operation:
   the first switch connects the first connection terminal to the second power supply cell and the second switch connects the first connection terminal to the third power supply cell, when all the power supply cells are connected to the connection module,
   the first switch of the connection module connects the second connection terminal to the second power supply cell and the second switch of the connection module connects the third connection terminal to the third power supply cell when only one power supply cell is connected to the connection module.

Advantageously, the electrical system comprises three power supply cells.

The invention also relates to an automotive vehicle comprising an electrical supply bus designed to supply power to electrical equipment installed in the vehicle and an electrical power supply system such as previously described.

### DESCRIPTION OF THE DRAWINGS

Other features and advantages of the invention will become apparent upon reading the description that follows. The latter is purely illustrative and must be read with regard to the appended drawings in which:

FIG. 1 is a diagram showing the power supply system according to the invention.

FIG. 2 is a diagram showing the first mode of operation of the power supply system according to the invention.

FIG. 3 is a diagram showing the second mode of operation of the power supply system according to the invention.

FIG. 4 is a diagram showing the third mode of operation of the power supply system according to the invention.

FIG. 5 is a diagram showing the fourth mode of operation of the power supply system according to the invention.

FIG. 6 is a diagram showing the fifth mode of operation of the power supply system according to the invention.

### DESCRIPTION OF THE EMBODIMENTS

### Vehicle

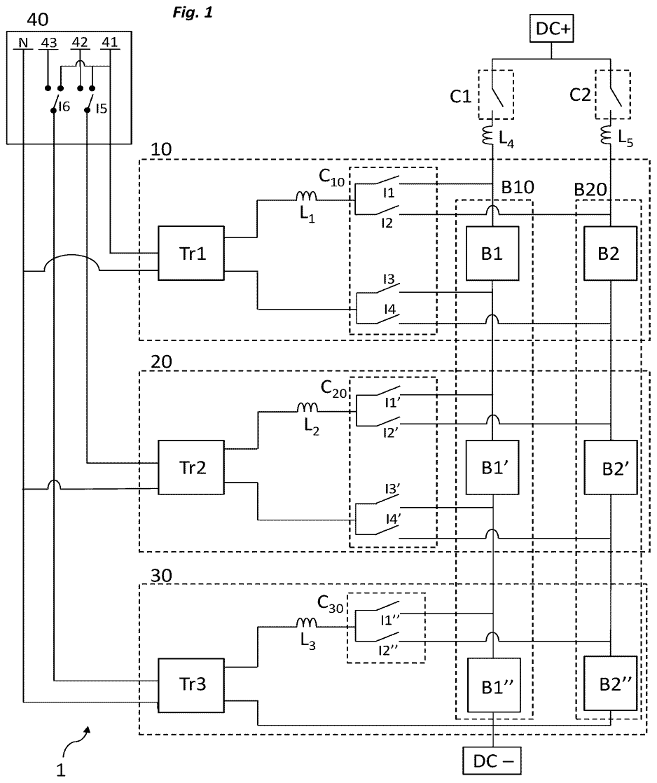

A vehicle according to the invention will now be described with reference to FIG. 1. The vehicle notably comprises a DC electrical power supply bus comprising a positive terminal DC+ and a negative terminal DC−. The electrical supply bus is on board the vehicle and is designed to supply electrical energy to various pieces of electrical equipment on board the vehicle. The power supply bus is commonly called “onboard supply system” by those skilled in the art.

The vehicle also comprises an electrical power supply system 1.

### Power Supply System

With reference to FIG. 1, the power supply system 1 comprises at least two power supply cells 10, 20, 30, a connection module 40, a first switching unit C1, a second switching unit C2 and a control unit (not shown in the figures).

Preferably, the power supply system 1 comprises a first power supply cell 10, a second power supply cell 20 and a third power supply cell 30. Each power supply cell 10, 20, 30 is designed to convert an AC voltage into a DC voltage.

### Power Supply Cell 10, 20, 30

Each power supply cell 10, 20, 30 comprises a transformer Tr1, Tr2, Tr3, a first battery B1, B1′, B1″, a second battery B2, B2′, B2″ and a switching cell C₁₀, C₂₀, C₃₀.

More precisely, the transformer Tr1, Tr2, Tr3 of each power supply cell 10, 20, 30 is “bidirectional”. In other words, each transformer Tr1, Tr2, Tr3 is designed to supply an AC voltage starting from a DC voltage and vice versa.

Each transformer Tr1, Tr2, Tr3 comprises two input terminals and two output terminals.

The first battery B1, B1′, B1″ is designed to operate according to a discharge mode, in which the first battery B1, B1′, B1″ is designed to supply a first DC voltage. Furthermore, the first battery B1, B1′, B1″ of each power supply cell 10, 20, 30 is also designed to operate according to a charging mode in which the first battery B1, B1′, B1″ receives electrical energy.

Similarly, the second battery B2, B2′, B2″ of each power supply cell 10, 20, 30 is designed to operate according to a discharge mode, in which the second battery B2, B2′, B2″ is designed to supply a second DC voltage. Furthermore, the second battery B2, B2′, B2″ of each power supply cell 10, 20, 30 is also designed to operate according to a charging mode in which the second battery B2, B2′, B2″ receives electrical energy.

Each first battery B1, B1′, B1″ and each second battery B2, B2′, B2″ comprises two connection terminals.

The switching cell C₁₀, C₂₀, C₃₀ of each power supply cell 10, 20, 30 is designed to connect the first battery B1, B1′, B1″ and/or the second battery B2, B2′, B2″ to the transformer Tr1, Tr2, Tr3.

More precisely, two switching cells C₁₀, C₂₀ comprise a first switch I1, I1′, I1″, a second switch I2, I2′, I2″, a third switch I3, I3′ and a fourth switch I4, I4′.

The first switch I1, I1′ of each power supply cell 10, 20, 30 allows a first terminal of the first battery B1, B1′ to be connected to the first output terminal of the transformer Tr1, Tr2 specific to said power supply cell 10, 20.

The second switch I2, I2′ of each power supply cell 10, 20, 30 allows a first terminal of the second battery B2, B2′ to be connected to the first output terminal of the transformer Tr1, Tr2 specific to said power supply cell 10, 20.

The third switch I3, I3′ of each power supply cell 10, 20 allows the second terminal of the first battery B1, B1′ to be connected to the second output terminal of the transformer Tr1, Tr2 specific to said power supply cell 10, 20.

The fourth switch I4, I4′ of each power supply cell 10, 20 allows the second terminal of the second battery B2, B2′ to be connected to the second output terminal of the transformer Tr1, Tr2 specific to said power supply cell 10, 20.

The third switching cell C₃₀ comprises a first switch I1″ and a second switch I2″. The first switch I1″ allows a first terminal of the first battery B1″ to be connected to the first output terminal of the transformer Tr3 specific to said power supply cell 30. The second switch I2″ allows a first terminal of the second battery B2″ to be connected to the first output terminal of the transformer Tr3 specific to said power supply cell 30.

The second terminal of the first and of the second battery B1″ and B2″ of the third power supply cell 30 are connected to a low point. The low point is notably connected to the negative terminal DC-of the power supply bus DC.

Moreover, the first batteries B1, B1′, B1″, respectively the second batteries B2, B2′, B2″, are connected in series. In other words, the second terminal of the first battery B1 is connected to the first terminal of the first battery B1′ and the second terminal of the first battery B1′ is connected to the first terminal of the first battery B1″. In an analogous manner, the second terminal of the second battery B2 is connected to the first terminal of the second battery B2′ and the second terminal of the second battery B2′ is connected to the first terminal of the second battery B2″.

The first batteries B1, B1′, B1″ thus connected constitute a first branch B10 and the second batteries B2, B2′, B2″ thus connected constitute a second branch B20.

Moreover, each switching cell C₁₀, C₂₀, C₃₀ comprises an inductor L1, L2, L3 connected, on the one hand, to the first switch I1, I1′, I1″ and to the second switch I2, I2′, I2″ specific to said switching cell C₁₀, C₂₀, C₃₀ and connected, on the other hand, to the transformer Tr1, Tr2, Tr3 specific to said switching cell C₁₀, C₂₀, C₃₀. The inductors L1, L2, L3 allow the current to be controlled by regulating the voltage across the terminals of each first battery B1, B1′, B1″ and second battery B2, B2′, B2″.

The first switching unit C1 is designed to connect one of the first batteries B1, B1′, B1″, more precisely the first battery B1, to the electrical supply bus. In other words, the first switching unit C1 allows the first branch B10 to be connected to the electrical supply bus DC+.

The second switching unit C2 is designed to connect one of the second batteries B2, B2′, B2″, more precisely the second battery B2, to the electrical supply bus. In other words, the second switching unit C2 allows the second branch B20 to be connected to the electrical supply bus DC+.

In addition, the power supply system 1 may comprise a fourth inductor L4 allowing the first switching unit C1 to be connected to the first battery B1 and a fifth inductor L5 allowing the second switching unit C2 to be connected to the second battery B2. The fourth inductor L4 and the fifth inductor L5 allow the DC voltage flowing at their terminals to be regulated.

### Connection Module 40

The connection module 40 is designed to be connected, on the one hand, to an AC electrical power supply system, or to electrical equipment external to the vehicle, and, other the other hand, to at least one of the power supply cells 10, 20, 30.

When the connection module 40 is connected to a power supply system, then the power supply system allows at least one battery B1, B1′, B1″, B2, B2′, B2″ of the at least one power supply cell 10, 20, 30 connected to said connection module 40 to be recharged.

When the connection module 40 is connected to electrical equipment, then at least one battery B1, B1′, B1″, B2, B2′, B2″ of the at least one power supply cell 10, 20, 30 connected to said connection module 40 allows power to be supplied to said equipment.

More precisely, if the AC voltage supplied by the power supply system, or if the voltage needed to supply power to the electrical equipment, is single-phase, then the connection module 40 is designed to connect the single-phase voltage to each power supply cell 10, 20, 30. If the AC voltage supplied by the power supply system, or if the voltage needed to supply power to the electrical equipment, is three-phase, then the connection module 40 is designed to connect each phase of said AC voltage to a power supply cell 10, 20, 30 specific to it.

More precisely again, the connection module 40 comprises a first connection terminal 41, a second connection terminal 42 and a third connection terminal 43.

When the AC voltage supplied by the power supply system, or when the voltage needed to supply power to the electrical equipment, is three-phase, then each phase of said voltage is connected to a connection terminal 41, 42, 43 specific to it. Conversely, when the AC voltage supplied by the power supply system, or when the voltage needed to supply the electrical equipment, is single-phase, the phase of said voltage is connected to the first connection terminal 41.

In addition, a first connection terminal 41 is connected to the first power supply cell 10, more precisely to an input terminal of the transformer Tr1 of the first power supply cell 10. A second connection terminal 42 is connected to the second power supply cell 20, more precisely to an input terminal of the transformer Tr2 of the second power supply cell 20. A third connection terminal 43 is connected to the third power supply cell 30, more precisely to an input terminal of the transformer Tr3 of the third power supply cell 30.

The connection module 40 also comprises:
a) a first switch I5, configured for:
   i) according to a first position: connecting the first connection terminal 41 to the second power supply cell 20, and more precisely to an input terminal of the transformer Tr2 of the second power supply cell 20,
   ii) according to a second position: connecting the second connection terminal 42 to the second power supply cell 20, and more precisely to an input terminal of the transformer Tr2 of the second power supply cell 20,
b) a second switch I6 configured for:
   i) according to a first position: connecting the first connection terminal 41 to the third power supply cell 30, and more precisely to an input terminal of the transformer Tr3 of the third power supply cell 30,
   ii) according to a second position: notably when the AC voltage supplied by the power supply system, or when the voltage needed to supply the electrical equipment, is three-phase, connecting the third connection terminal 43 to the third power supply cell 30, and more precisely to an input terminal of the transformer Tr3 of the third power supply cell 30.

By default, the first switch I5 and the second switch I6 are in the second position.

In addition, the connection module 40 is also connected to the neutral line N of the AC voltage and the connection module 40 is configured for connecting the neutral line N to the second input terminal of each transformer Tr1, Tr2, Tr3.

Furthermore, each power supply cell 10, 20, 30 may also comprise an EMC filter, for “electromagnetic compatibility”, connected between each transformer Tr1, Tr2, Tr3 and the connection module 40.

With reference to FIGS. 1, 2, 4 and 6, when the voltage is three-phase, the first switch I5 and the second switch I6 of the connection module 40 operate according to the second position and each phase of said voltage is electrically connected to a connection terminal 41, 42, 43.

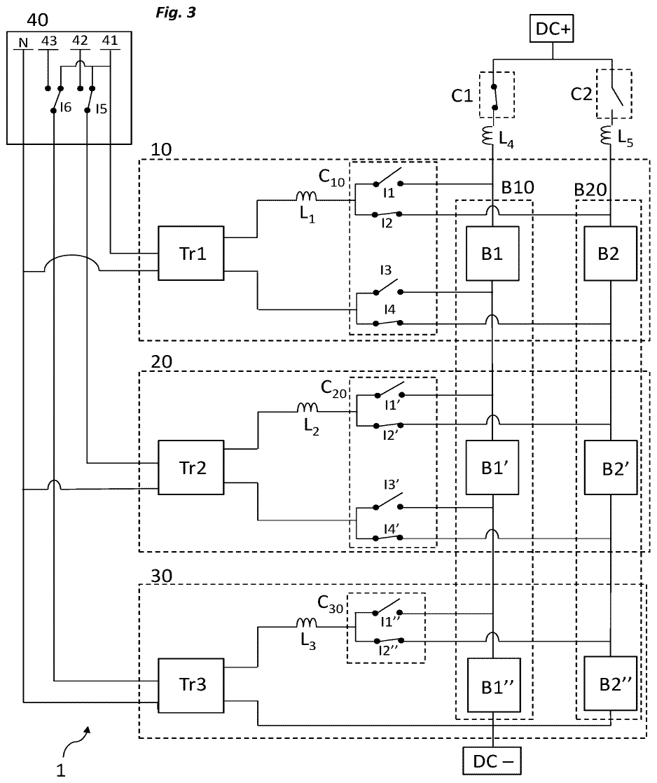

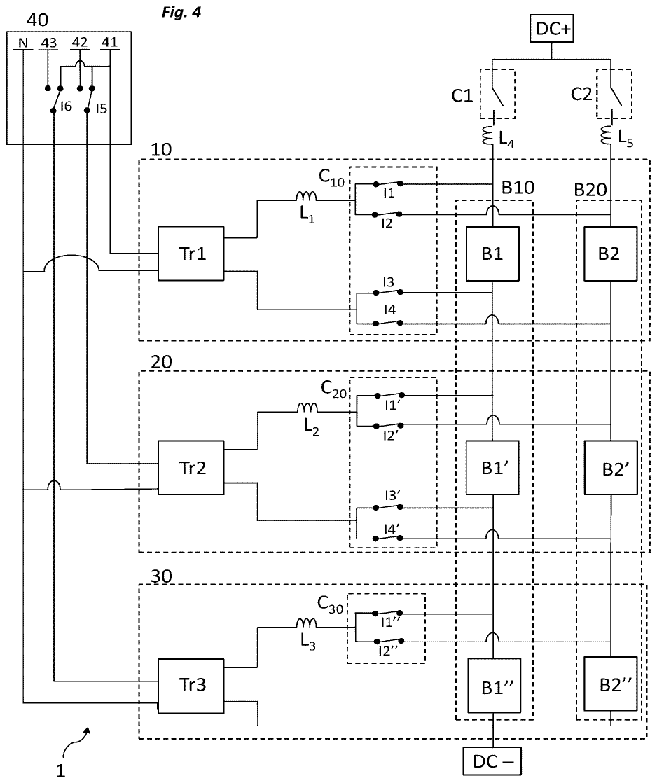

With reference to FIGS. 3 and 4, when the voltage is single-phase, said single-phase voltage is connected to the first connection terminal 41 and the first switch I5 and the second switch I6 of the connection module 40 operate according to the first position. Thus, the single-phase voltage is connected to the three power supply cells 10, 20, 30.

The control unit (not shown in the figures) is configured for controlling the switches I5, I6 of the connection module 40, of the first switching unit C1 and of the second switching unit C2, each switch of each power supply cell 10, 20, 30 and each transformer Tr1, Tr2, Tr3. The control unit allows also the voltage generated and supplied by each battery B1, B1′, B1″, B2, B2′, B2″ to be controlled, in order for example to regulate the current in the inductors L1, L2, L3 or to regulate the voltage supplied by the DC power supply bus.

### Modes of Operation

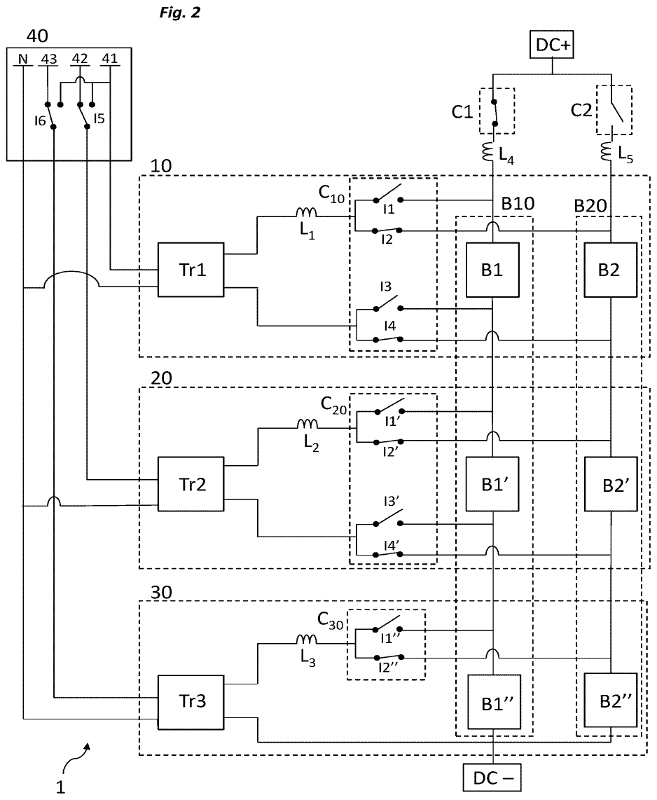

With reference to FIGS. 2 to 6, the various modes of operation of the power supply system 1 such as previously described will now be described. Preferably, the power supply system 1 has five different modes of operation.

### 1st MoO (Three-Phase, B10 to DC and B20 to 40)

When the power supply system 1 operates according to the first mode of operation, the first battery B1, B1′, B1″ or the second battery B2, B2′, B2″ of each power supply cell 10, 20, 30 is connected to the electrical supply bus of the vehicle, and notably connected between the positive terminal DC+and the negative terminal DC-. The first battery B1, B1′, B1″ or the second battery B2, B2′, B2″ not connected to the power supply bus is connected to the connection module 40.

In other words, one branch from between the first branch B10 and the second branch B20 is connected to the power supply bus, and notably connected between the positive terminal DC+ and the negative terminal DC−, in order to supply electrical energy to the electrical equipment installed in the vehicle, and the other branch is connected to the connection module 40 in order to supply electrical energy to equipment external to the vehicle or in order to recharge the batteries of said branch from an AC power supply system.

According to the example shown in FIG. 2, the first branch B10 is connected to the power supply bus, and notably connected between the positive terminal DC+ and the negative terminal DC−. For this purpose, the first switching unit C1 is closed. In addition, the second branch B20 is connected to the connection module 40. For this purpose, on the one hand, each first switch I1, I1′, I1″ and each third switch I3, I3′ is open, and, on the other hand, each second switch I2, I2′, I2″ and each fourth switch I4, I4′ is closed.

The first mode of operation also represents the case where the voltage supplied by the electrical supply system, or the voltage to be supplied to the electrical equipment connected to the connection module 40, is three-phase. The fifth switch I5 and the sixth switch I6 operate according to the second position. Each phase of the three-phase voltage is connected to a connection terminal 41, 42, 43 specific to it.

### 2nd MoO (Single-Phase, B10 to DC and B20 to 40)

With reference to FIG. 3, the power supply system 1 is shown operating according to the second mode of operation, in which the connection module 40 connects the single-phase voltage to the assembly of the power supply cells 10, 20, 30.

For each power supply cell 10, 20, 30:
a. the first battery B1, B1′, B1″ or the second battery B2, B2′, B2″ is connected to the power supply bus DC, and notably connected between the positive terminal DC+ and the negative terminal DC−,
b. the battery not connected to the power supply bus operates according to the charging or discharge mode.

Since the voltage is single-phase, the fifth switch I5 and the sixth switch I6 operate according to the first position.

### 3rd MoO (Single-Phase, All the Batteries Connected to Module 40)

With reference to FIG. 4, when the power supply system 1 operates according to the third mode of operation, the connection module 40 connects the single-phase voltage to all of the power supply cells 10, 20, 30.

In addition, each switch of each power supply cell 10, 20, 30 is closed. Finally, the first switching unit C1 and the second switching unit C2 are open, such that each battery operates according to the charging mode or according to the discharge mode.

Thus, each of the first batteries B1, B1′, B1″ and of the second batteries B2, B2′, B2″ of each power supply cell 10, 20, 30 connected to the single-phase voltage is connected to the connection module 40 via a transformer Tr1, Tr2, Tr3.

Notably, if the connection module 40 is connected to electrical equipment external to the vehicle, then each of the connected batteries operates according to the discharge mode and allows said equipment to be powered.

Conversely, if the connection module 40 is connected to a power supply system external to the vehicle, then each of the connected batteries operates according to the charging mode and is supplied from the electrical energy supplied by said electrical system.

The fifth switch I5 and the sixth switch I6 operate according to the first position.

Thus, either the single-phase voltage allows the batteries of the first branch B10 and of the second branch B20 to be recharged, or the batteries allow electrical equipment which operates from a single-phase voltage to be recharged.

### 4th MoO (Three-Phase, All the Batteries Connected to Module 40)

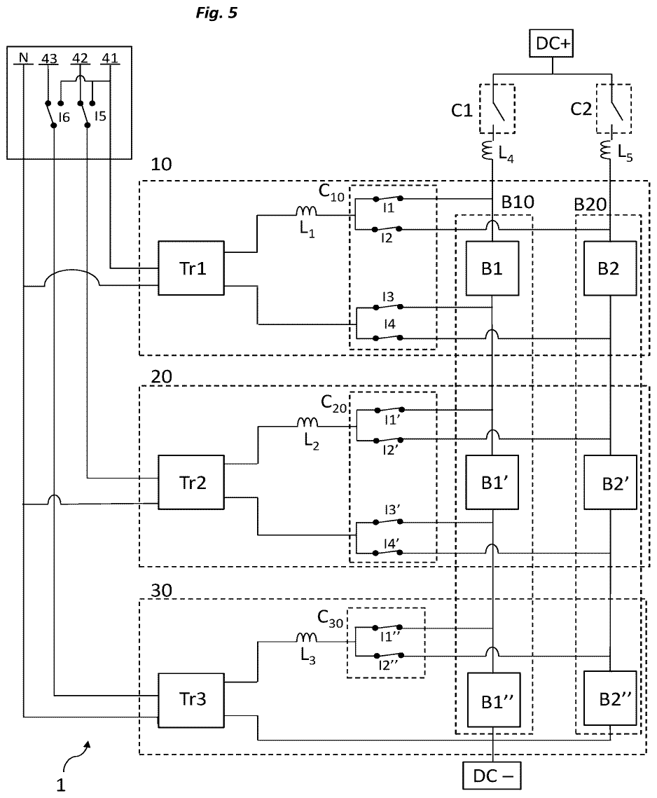

With reference to FIG. 5, when the power supply system 1 operates according to the fourth mode of operation, all the switches of each power supply cell 10, 20, 30 are closed, and the first switching unit C1 and the second switching unit C2 are open, as in the case where the power supply system 1 operates according to the third mode of operation.

However, in the present case, the fourth mode of operation represents the case where the voltage supplied by the electrical supply system, or the voltage to be supplied to the electrical equipment connected to the connection module 40, is three-phase. The fifth switch I5 and the sixth switch I6 operate according to the second position in order for each phase of said three-phase voltage to be connected to a connection terminal 41, 42, 43.

Thus, either the three-phase voltage allows all of the batteries of the first branch B10 and of the second branch B20 to be recharged, or all of the batteries allow electrical equipment which operates from a three-phase voltage to be powered.

### 5th MoO

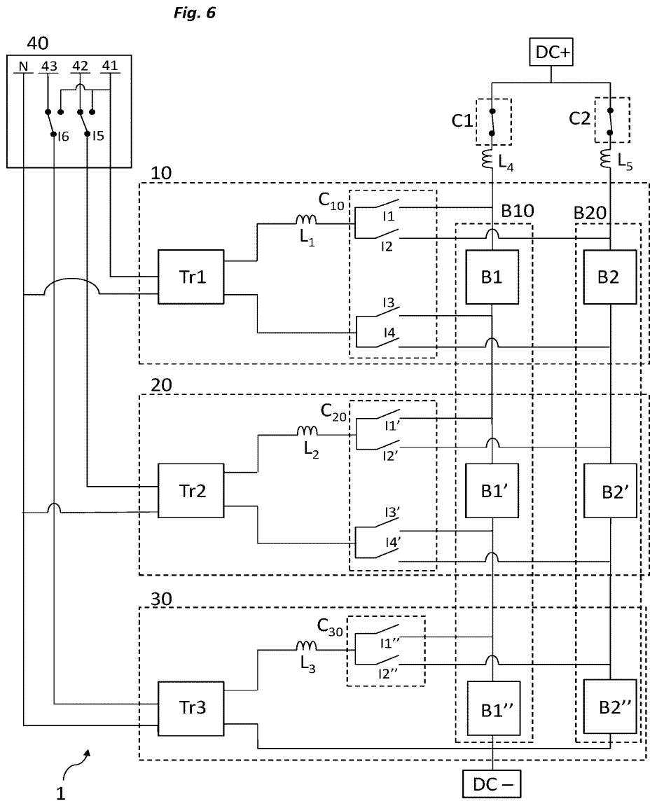

With reference to FIG. 6, when the power supply system 1 operates according to the fifth mode of operation, the first switching unit C1 and the second switching unit C2 are closed, and all the switches of each of the switching cells C₁₀, C₂₀, C₃₀ are open.

Thus, the first battery B1, B1′, B1″ and the second battery B2, B2′, B2″ supply electrical energy to the power supply bus. The electrical equipment on board the vehicle is therefore supplied from the energy supplied by the first branch B10 and the second branch 20.

1. An electrical power supply system for an electric or hybrid vehicle, the vehicle comprising an electrical power supply bus configured to supply electrical equipment installed in the vehicle, the system comprising:
a) at least two power supply cells each comprising:
i) a bidirectional transformer configured to supply an AC voltage starting from a DC voltage and vice versa,
ii) a first battery configured to operate according to a discharge mode, in which the first battery is configured to supply a first DC voltage, and configured to operate according to a charging mode in which the first battery is configured to be recharged from a DC voltage,
iii) a second battery configured to operate according to a discharge mode, in which the second battery is configured to supply a first DC voltage, and configured to operate according to a charging mode in which the second battery is configured to be recharged from a DC voltage, and
iv) a switching cell comprising switches configured to connect the first battery and/or the second battery to the transformer,
b) a first switching unit configured to connect the first battery of each power supply cell to the electrical supply bus,
c) a second switching unit configured to connect the second battery to the electrical supply bus,
d) a connection module configured to electrically connect each power supply cell to an electrical power supply system, configured to supply an AC voltage, or to electrical equipment external to the vehicle, and configured to be supplied from an AC voltage:
i) if the AC voltage supplied by the power supply system, or if the voltage needed to supply the electrical equipment, is single-phase, the connection module is configured to connect the single-phase voltage to at least one of the power supply cells, and
ii) if the AC voltage supplied by the power supply system, or if the voltage needed to supply the electrical equipment, is three-phase, the connection module is configured to connect each phase of the voltage to one of the power supply cells specific to each phase, and
e) a control unit configured for controlling the connection module, the first switch and the second switch,
the electrical system is configured to operate according to a plurality of operating modes:
i) a first mode of operation in which the connection module connects each phase of the three-phase voltage supplied by the power supply system to the power supply cell specific to each phase and, for each power supply cell
1) the first battery or the second battery is connected to the power supply bus, and
2) the battery not connected to the power supply bus is connected to the connection module and operates according to the charging or discharge mode, and
ii) a second mode of operation in which the connection module connects the single-phase voltage supplied by the power supply system to at least one power supply cell and, for each power supply cell connected to the single-phase voltage:
1) the first battery or the second battery is connected to the power supply bus, and
2) the battery not connected to the power supply bus is connected to the connection module and operates according to the charging or discharge mode.

2. The power supply system as claimed in claim 1, wherein an assembly of the first batteries of each power supply cell is connected in series, and the assembly of the second batteries of each power supply cell is connected in series.

3. The electrical power supply system as claimed in claim 1, being configured to operate according to:
a) a third mode of operation in which:
i) the connection module connects the single-phase voltage to at least one power supply cell,
ii) each switch of each power supply cell connected to the single-phase voltage is closed, and
iii) the first switch and the second switch are open, such that each of the first and second batteries operates according to the charging mode or according to the discharge mode, and
b) a fourth mode of operation in which:
i) the connection module is designed to connect each phase of the voltage to a power supply cell specific to it,
ii) each switch of each power supply cell is closed, and
iii) the first switching unit and the second switching unit are open, such that each of the first and second batteries operates according to the charging mode or according to the discharge mode.

4. The electrical power supply system as claimed in claim 3, the system being configured for operating according to a fifth mode of operation in which the first switch and the second switch are closed, each switch of each power supply cell being open, such that the first battery and the second battery supply electrical energy to the power supply bus.

5. The power supply system as claimed in claim 1, wherein the connection module comprises:
a) a first connection terminal electrically connected to a first one of the power supply cells,
b) a second connection terminal,
c) a third connection terminal,
d) a first switch configured to connect a second one of the power supply cells to the first connection terminal or to the second connection terminal, and
e) a second switch configured to connect a third one of the power supply cells to the first connection terminal or to the third connection terminal.

6. The power supply system as claimed in claim 5, wherein:
f) the first connection terminal is electrically connected to the transformer of the first power supply cell,
g) the first switch is configured to connect the transformer of the second power supply cell to the first connection terminal or to the second connection terminal, and
h) the second switch is configured to connect the transformer of the third power supply cell to the first connection terminal or to the third connection terminal.

7. The power supply system as claimed in claim 5, wherein:
a) when the system operates according to the first mode of operation, the first switch of the connection module connects the second connection terminal to the second power supply cell and the second switch of the connection module connects the third connection terminal to the third power supply cell, and
b) when the system operates according to the second mode of operation:
the first switch connects the first connection terminal to the second power supply cell and the second switch connects the first connection terminal to the third power supply cell, when all the power supply cells are connected to the connection module, and
the first switch of the connection module connects the second connection terminal to the second power supply cell and the second switch of the connection module connects the third connection terminal to the third power supply cell when only one power supply cell is connected to the connection module.

8. The power supply system as claimed in claim 1, comprising three of the power supply cells.

9. An automotive vehicle comprising an electrical power supply bus configured to supply electrical equipment installed in the vehicle and an electrical power supply system as claimed in claim 1.
